(19) United States
(12) Patent Application Publication
(10) Pub. No.: US 2005/0277535 A1
(43) Pub. Date: Dec. 15, 2005

(54) Method for covering a plastic cup with a print substrate

(76) Inventor: Werner Heinz Wilke, Ratingen (DE)

Correspondence Address: Walter A Hackler;Pattent Law Office, 2372 S E Bristol Street, Suite B, Newport Beach, CA, 92660-0755, US

(21) Appl. No.: 10/527,309

(22) PCT Filed: Sep. 3, 2003
(86) PCT No.: PCT/DE03/02908

§ 371 Date: Mar. 9, 2003

(30) Foreign Application Priority Data
Sep. 11, 2002 (DE) 10242089.0

(51) Int. Cl. B31B 1/88

(52) U.S. Cl. 493/320

(57) ABSTRACT

The invention relates to a method for covering a plastic cup with a print substrate (2) that is flatly folded together along two folding lines (5). The inventive method comprises the following steps: A form (12) having the contour of the plastic cup is provided with an insertion slot (13) for the folded together print substrate (2). The flatly folded together print substrate of the form is fed with an direction of insertion (11) transversal to the folding lines (5), whereby the diameter of the form (12) is smaller than the extension of the folded together print substrate (2) transversal to the folding lines (5). The folded together print substrate (2) is completely inserted into the form (12), whereby an automatic unfolding of the print substrate (2) and a placement against the inner wall of the form (12) ensues. A plastic cup is placed inside the form (12) that is lined with the print substrate (2).

The invention concerns a method for covering a plastic cup with a print substrate which is flatly folded together using two folding lines and which may e.g. be a collar or band or the like made from cardboard, paper, carton or plastic material.

WO 01/21382 A1 discloses a folded print substrate for a plastic cup which can be erected.

A method for covering a plastic cup is disclosed e.g. in DE 299 11 272 U1.

DE 299 11 272 U1 describes a machine for serially deep-drawing plastic cups and for mounting a print substrate onto the outer side of the plastic cup. The conventional machine comprises a mold housing with mold cavities whose bottom is provided with an opening for introducing the print substrate from a region below the mold cavity bottom into the form space of the mold cavities using a lifting member.

U.S. Pat. No. 4,497,156 describes a method for unfolding folded closing sleeves through exertion of pressure onto the folding lines and putting these over the lid of bottles.

It is the object of the present invention to develop a method which improves mounting of the print substrates.

This object is achieved in accordance with the invention with a method comprising following step sequence to be carried out one after the other:
the print substrate is flatly folded using two folding lines;
a form (erecting form) with an insertion slot for the folded print substrate is provided, which has the contour of the plastic cup;
the flatly folded print substrate is supplied to the form in an inserting direction transverse to the folding lines, wherein the diameter of the form is smaller than the extension of the folded print substrate transversely to the folding lines;
the folded print substrate is completely introduced into the form, thereby automatically erecting the print substrate and disposing it on the inner wall of the form;
a plastic cup is inserted into the form lined with the print substrate.

The print substrates are pre-confectioned through gluing into a sleeve and subsequent flat folding.

In a preferred further development of the inventive method, a transport means is provided to move the forms and form groups of forms with the desired effective number which corresponds in general to grouping the cups on the upstream system. This system serves for the production of plastic cups and/or filling of plastic cups. During grouping and transport of the forms, a subsequent form pushes the folded print substrate into the previous form. This improves automation of the machine and omits separate lifting members for moving and introducing the print substrates into the form.

It is also reasonable to provide the print substrate with bottom parts which can be folded inward between the folded print substrate parts. The print substrate bottom automatically unfolds while the print substrate is erected. The plastic cup is inserted such that the peripheral surface and the bottom are covered.

Further advantages of the invention can be extracted from the description and the drawing. The features mentioned above and below may be used in accordance with the invention either individually or collectively in arbitrary combination. The embodiment shown and described is not to be understood as exhaustive enumeration but has exemplary character for describing the invention.

A preferred embodiment of the invention is schematically shown in the drawing and is explained in more detail with reference to the drawing.

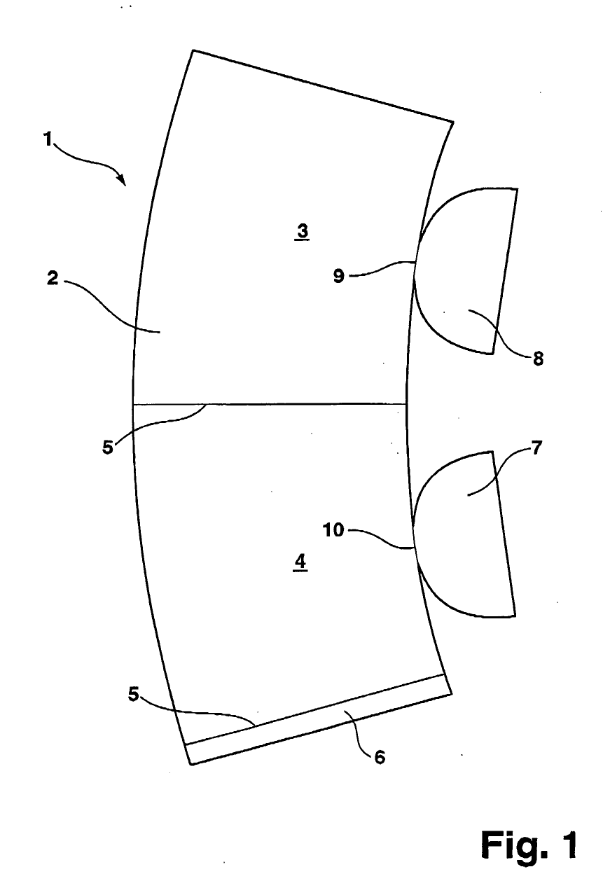

FIG. 1 shows a top view onto a blank of a print substrate for covering a plastic cup;

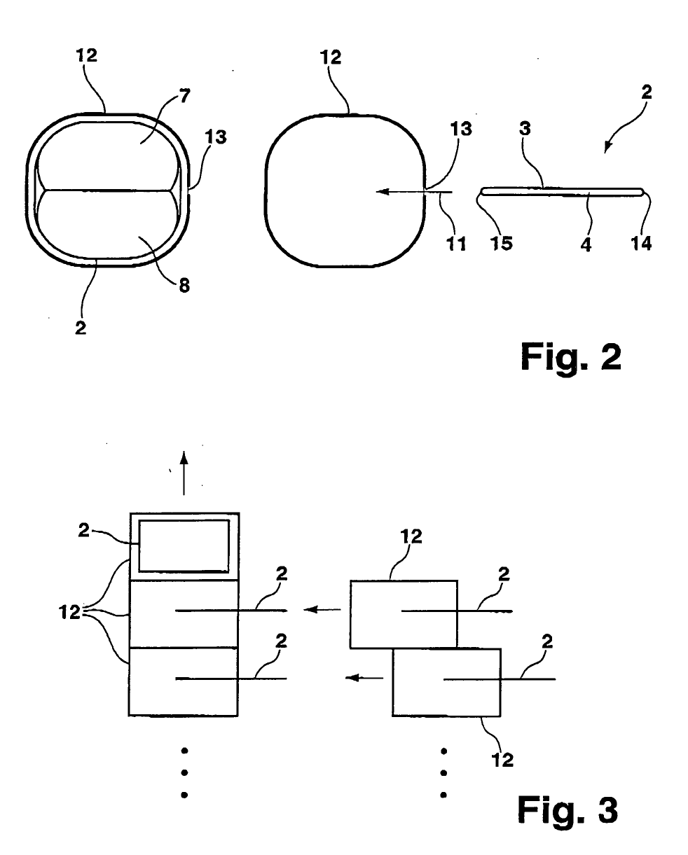

FIG. 2 shows a schematic diagram of a method for erecting the print substrate of FIG. 1;

FIG. 3 shows a combination of the method of FIG. 2 with a machine for grouping forms provided with print substrates.

FIG. 1 shows that a blank 1 for forming a print substrate 2 with a round cross-section in the erected state, comprises two print substrate parts 3 and 4 of identical size which are separated by a correspondingly treated first folding line 5. A second folding line 5 permits folding of a print substrate 2 connected into a sleeve (FIG. 2). The print substrate parts 3 and 4 can be connected using an adhesive tab 6. Two bottom parts 7 and 8 are connected to the print substrate 2 via the folding lines 9 and 10, Before processing, the print substrate 2 is flatly folded to the size of a print substrate part 3 or 4. The bottom parts 7 and 8 are thereby folded inwards.

The schematic diagram in accordance with FIG. 2 shows processing of the flatly folded print substrate 2. The print substrate 2 prepared in this manner, is supplied in the direction of arrow 11 (insertion direction) to a form 12 with a lateral insertion slot 13 which extends in the longitudinal direction of the form and extends to the bottom of the form 12. The form 12 is designed with the contour of a plastic cup and is slightly larger than the plastic cup. Through exertion of pressure onto the end 14 of the print substrate 2, the latter is pushed into the form 12 until the opposite end 15 of the print substrate 2 hits the inner wall of the form 12. A further pressure load through further pushing causes erection of the folded print substrate 2 inside the form 12 due to the generated tension. At the same time, the bottom parts 7 and 8 fold down and form a cardboard bottom. A plastic cup which is not shown in FIG. 2 can be inserted into the form 12 and into the erected print substrate 2. If the form 12, print substrate 2 and plastic cup are correspondingly dimensioned, the print substrate 2 flatly abuts the plastic cup. The plastic cup can be pulled out of the form 12 together with the abutting print substrate 2 to produce a unit of plastic cup and print substrate 2. The connection between plastic cup and print substrate 2 can be supported through suitable adhesive means.

FIG. 3 indicates combined use of the inventive method with a machine for grouping forms (erecting forms). The machine may also be regarded as an invention. The method can combine and pre-confection forms 12 and print substrates 2 in connection with a transport means, such that subsequently deep-drawn plastic cups can be inserted directly in the print substrates 2 erected in the form 12. The transport of the forms 12 and print substrates 2 can thereby be coordinated such that the ends of the print substrates are pressure-loaded by the motion of the forms 12 and are thereby pushed into the forms 12. In addition to “automatic” pushing of the print substrates 2 into previous forms 12 through subsequent forms 12, additional pushing means may be provided for inserting print substrates 2. This is required, in particular, if a unit of form 12 and print substrate 2 has no interacting partner unit.

### List of Reference Numerals

1 blank
2 print substrate
3 print substrate part
4 print substrate part
5 folding line
6 adhesive tab
7 bottom part
8 bottom part
9 folding line
10 folding line
11 insertion direction
12 form
13 insertion slot
14 end
15 end

1-2. (canceled)

3. A method for covering a plastic cup with a print substrate, said method comprising:
flatly folding the substrate;
inserting the flatly folded substrate into a form through an insertion slot, the form having a diameter smaller than a width of the flatly folded substrate;
erecting the flatly folded substrate within the form by pushing the flatly folded substrate against an inner wall of said form, upon erection the substrate abutting and lining the form inner surface; and
inserting the plastic cup into the form lined with the print substrate.

4. The method according to claim 3 further comprising adhering the plastic cup to the print substrate.

5. The method according to claim 3 further comprising moving the form in a manner such that a subsequent form pushes the fully folded substrate into a previous form.
